(19) United States
(12) Patent Application Publication
(10) Pub. No.: US 2005/0218172 A1
(43) Pub. Date: Oct. 6, 2005

(54) Entertainment device storage case adapted for interconnection to a vehicle seat

(76) Inventor: Eric S. Hassett, Golden, CO (US)

Correspondence Address: SHERIDAN ROSS PC, 1560 BROADWAY, SUITE 1200, DENVER, CO, 80202, US

(21) Appl. No.: 11/095,037

(22) Filed: Mar. 30, 2005

Related U.S. Application Data
(63) Continuation-in-part of application No. 29/203,199, filed on Apr. 9, 2004.
(60) Provisional application No. 60/558,975, filed on Apr. 1, 2004.

(51) Int. Cl. G05D 1/00; G05D 3/00; G06F 7/00; A45F 4/00; G06F 17/00; A45C 15/00

(52) U.S. Cl. 224/585

(57) ABSTRACT

A storage case is provided which is adapted to secure an entertainment device, such as a portable DVD player or other electronics device which may be selectively interconnected to one seat or alternatively between two seats of a vehicle. Preferably, the present invention includes a plurality of adjustable straps which may be selectively interconnected to a plurality of strategically placed retention rings or loops.

This application claims the benefit of U.S. provisional patent application Ser. No. 60/558,975 which was filed on Apr. 1, 2004, and is a continuation-in-part of U.S. patent application Ser. No. 29/203,199, filed Apr. 9, 2004, both applications being incorporated herein in their entirety by reference.

### FIELD OF THE INVENTION

The present invention relates to a storage case for securing an entertainment device, such as a portable DVD player. More specifically, one embodiment of the present invention is adapted for interconnection to at least one seat generally found in a vehicle, such as an automobile, and alternatively for positioning between two seats.

### BACKGROUND OF THE INVENTION

It is sometimes desirous to entertain passengers and especially children seated in the rear compartment of a vehicle, because often they find it difficult to hear and understand passengers seated in the front compartment of the vehicle, thus carrying on a conversation is difficult. Often, passengers in the rear compartment of the vehicle choose to pass time by using an entertainment device such as a television, VCR, DVD player, cassette tape player, computer, computer game, etc. (hereinafter “entertainment device”).

Many jurisdictions dictate that children be seated in the rear compartment of an automobile to prevent serious injury due to a collision or from the deployment of airbags, which are generally located in the front compartment of the vehicle. Since children are usually seated in the rear compartment of the vehicle, interaction with the driver is impractical and often dangerous. Alternatively, if two people are riding in the vehicle, one must sit in the rear to tend to the child, making conversation therebetween distracting and difficult. As most parents will appreciate, children tend to become bored without a sufficient amount of stimulation when traveling on long car trips, which can lead to distraction of the operator of the vehicle if the child becomes disruptive. Many modern vehicles employ entertainment devices to occupy children, either integrated into the ceiling or front seats thereof. Although entertainment devices provide children with sufficient stimulation during a trip, many consumers cannot afford a vehicle that includes these types of amenities. Thus, the child is left to his or her own devices to entertain themselves during a long journey, which may lead to disruptive behavior.

Entertainment devices have been transported in vehicles in the past. Often, for example, the entertainment device is simply placed on a console of the vehicle. One drawback of this method of transporting entertainment devices is that sudden stops or turns will certainly turn the unsecured entertainment device into a dangerous projectile inside the vehicle, which may potentially harm the passengers or driver. Examples of prior art designs include U.S. Pat. Nos. 6,473,315, 6,097,448, 6,092,705 and 5,771,305. However, none of these devices are designed to allow the storage case to be selectively interconnected in two different locations, i.e., behind a single vehicle seat, or alternatively between two vehicle seats, while also allowing the storage device to be carried with a handle between two locations.

A related drawback to simply transporting an unsecured entertainment device in the rear compartment of an automobile is that upon sudden stops and turns the expensive entertainment devices may be damaged. Thus, it is impractical, dangerous and potentially expensive to utilize electronic devices in a vehicle without some form of restraint device, or protective case.

A second related drawback to simply transporting an unsecured entertainment device in the rear portion of the vehicle is that there is often no convenient area for the storage of media generally used with the entertainment device. This drawback may lead to a disorganized or messy vehicle, especially during long trips. In addition, expensive media such as DVDs, computer games, etc., may become damaged because they are not properly stored during a long trip.

Thus, there is a long felt need in the field of entertainment device storage to provide a device that is adapted to secure an electronic device, and in addition interconnect to at least one seat of a vehicle, or alternatively between two seats, and thus providing a safe and easily accessible storage location for an entertainment device. One example of an embodiment of the present invention is disclosed in the Applicant's U.S. Pat. No. D501,997S, which is incorporated herein by reference in its entirety.

The following disclosure describes a device that is adapted for interconnection to one or two seats of a vehicle, such as an automobile or an airplane, wherein a compartment is provided that secures an entertainment device such as a portable DVD player.

### SUMMARY OF THE INVENTION

It is one aspect of the present invention to provide a storage case that secures an entertainment device. More specifically, one embodiment of the present invention is adapted for use with an entertainment device such as a portable television, a VCR, a portable DVD player, a CD player, a computer game, a computer, etc. (hereinafter “entertainment device”). One embodiment of the present invention generally includes a base portion that supports the entertainment device, and a closure portion that is operably interconnected to the base portion, thus totally enveloping the entertainment device for protection when the closure portion is closed to the base portion. In addition, the closure portion and/or base portion may include a plurality of pockets or compartments for securing periphery items that are generally used with the entertainment device. In addition, this embodiment of the present invention also includes at least one handle that aids in the transportation of the case and entertainment device.

It is another aspect of the present invention to provide a storage case for entertainment devices that is easily and quickly interconnected to at least one seat of a vehicle, and alternatively two seats without requiring additional attachment hardware. More specifically, one embodiment of the present invention includes a plurality of rings or other attachment hardware that are adapted for interconnection with securing devices, such as clips or buckles, which are in turn interconnected to straps for attachment to at least one seat in the vehicle. Alternatively, the buckle or clip or other interconnection means may be interconnected to the storage case, while the rings are interconnected to the straps. With any alternative design, the storage case may be suspended between two bucket seats of the vehicle, or alternatively may be interconnected to the rear portion of the seat to provide viewing for occupants sitting in the rear portion of the vehicle. In addition, the use of straps with securing devices for selective interconnection to the rings of the case make the present invention quickly deployable in any situation, thus making it easy to use and transport.

It is yet another aspect of the present invention to provide a storage case for an entertainment device which is safe and provides protection to the entertainment device. Preferably, one embodiment of the present invention is constructed from cushioned components such that any impact will cause little damage. In addition, the present invention is designed for selective interconnection to one or more seats within a vehicle, thus restricting movement and providing an improved viewing experience for the user.

It is a related aspect of the present invention to provide a storage case for entertainment devices that protects the device contained therein. More specifically, one embodiment of the present invention employs padded, compliant materials, wherein the entertainment device is sufficiently protected from impact. Alternatively, as it will be understood by one skilled in the art, the device of the present invention may be constructed of a more rigid material such as molded plastic, etc. that will provide increased protection from an inadvertent impact. One embodiment of the present invention, as described briefly above, is constructed of a base portion and a cover portion, which are hingedly interconnected along at least one edge, and selectively closed and secured with a securing means, such as a zipper, buckle, hook and loop material, etc. However, other interconnecting means may be used without departing from the scope of the invention, such as zip locks, snaps, etc. The securing mechanism between the cover portion and the base portion may also include a mechanism that helps prevent the infiltration of fluids inside the case, which may damage delicate electronic componentry.

It is still yet another aspect of the present invention to provide a storage case that includes a storage location for media or other items generally used with the entertainment device. More specifically, one embodiment of the present invention employs a plurality of pockets or storage compartments that secure items such as CDs, DVDs, tapes, games, disks, books, manuals, magazines, pens, pencils, markers, etc. It should be understood by one skilled in the art that the list of items that may be stored by the present invention is not exhaustive, for example periphery components such as cords, disc drives, speakers, MP3 players, keyboards, mice, data storage devices, wireless network detectors, cellular phones, earphones, etc. may be stored inside the case without departing from the scope of the invention. Further, the pockets used and described herein may be customized for the items they are carrying such as slots for securing a DVD, for example.

It is yet another aspect of the present invention to provide a storage case that is easily transitioned from an open position to a closed position, and thus quickly deployed in a vehicle. As briefly described above, one embodiment of the present invention utilizes a plurality of straps for interconnection to at least one seat of a vehicle. One embodiment of the present invention is deployed such that the entertainment device is situated inside the base portion of the device wherein, upon opening of the storage device, the screen may be viewed easily. In addition, one embodiment of the present invention is provided with at least two gussets situated on either side of the entertainment device to provide support between the closure portion and the base portion and to also to provide locations for the interconnection of suspension straps. Furthermore, the gussets may be utilized for lateral support for the entertainment device, and to prevent the closure portion from being over-extended from the base portion, i.e., no greater than about 90-120 degrees. The gusset is further designed to provide shade to the viewing screen of the DVD Player, and thus enhance viewing.

It is still yet another aspect of the present invention to provide a storage case for entertainment devices that is constructed of commonly used materials and easy to manufacture, thus inexpensive to make. One embodiment of the present invention is constructed of a compliant material, such as leather, polyester, neoprene, nylon, cloth, or a combination thereof. Alternatively, another embodiment of the present invention may be constructed of at least partially rigid materials, such as hard plastic, to provide increased protection to the contents therein. The compliant materials may be stitched onto each other to provide a series of panels and compartments. The present invention may also include a series of ventilation panels, or utilize heat resistant materials, to allow for heat often generated by electronic equipment to be dissipated to prevent overheating of the entertainment device or heat damage to the storage case.

Thus, it is one aspect of the present invention to provide a storage case adapted for interconnection to at least one seat and for securing an entertainment device, comprising:
a base portion defined by a front edge, a rear edge, and two lateral edges extending therebetween, said base portion operatively sized to support said entertainment device;
a closure portion defined by a front edge, a rear edge, and two lateral edges extending therebetween, said closure portion hingedly interconnected along at least said rear edge to said base portion, wherein said closure portion can be selectively opened and closed;
a securement means operably interconnected to an interior surface of at least one of said base portion and said closure portion which is adapted to retain said electronic entertainment device within said storage device;
at least one interconnection means interconnected to each of said lateral edges of said base portion and said closure portion, and which is adapted for interconnection to a strap which is sized to secure said storage device to the vehicle seat; and
a closure means interconnected to at least a portion of said base portion and said closure portion, wherein said storage device can be selectively secured in a closed position;
The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1 is a perspective view of one embodiment of the present invention;

FIG. 2 is a front elevation view of the embodiment of the present invention FIG. 1;

FIG. 3 is a rear elevation view of the embodiment of the present invention shown in FIG. 1;

FIG. 4 is a right elevation view of the embodiment of the present invention shown in FIG. 1;

FIG. 5 is a left elevation view of the embodiment of the present invention shown in FIG. 1;

FIG. 6 is a top plan view of the embodiment of the present invention shown in FIG. 1;

FIG. 7 is a bottom plan view of the embodiment of the present invention shown in FIG. 1;

FIG. 8 is a perspective view of one embodiment of the present invention interconnected to a plurality of vehicle seats;

FIG. 9 is one embodiment of the present invention shown interconnected to a single seat of a vehicle; and

FIG. 10 is a perspective view of the present invention shown in a closed position for transportation.

To assist in the understanding of the present invention the following list of components and associated numbering found in the drawings is provided herein:

| Component | # |
|---|---|
| Storage device | 2 |
| Seat | 4 |
| Base portion | 6 |
| Closure portion | 8 |
| Strap | 10 |
| Gusset | 14 |
| Entertainment device | 18 |
| Securing device | 20 |
| Retention loop or ring | 22 |
| Upper retention loop or ring | 22A |
| Gusset ring | 22B |
| Lower base retention loop or ring | 22C |
| Upper base retention loop or ring | 22D |
| Zipper | 24 |
| Sidewall | 26 |
| Web | 30 |
| Handle | 32 |
| Tab | 34 |
| Compartment | 36 |
| Studs | 38 |
| Headrest | 40 |
| Opening angle α | 42 |

It should be understood that the drawings are not necessarily to scale. In certain instances, details which are not necessary for an understanding of the invention or which render other details difficult to perceive may have been omitted for clarity. It should be understood that the invention is not necessarily limited to the particular embodiments illustrated herein.

### DETAILED DESCRIPTION

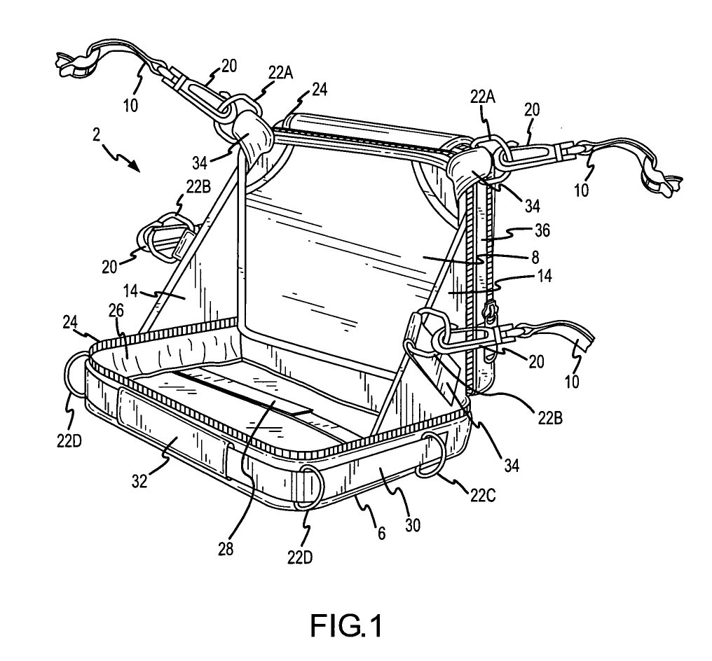

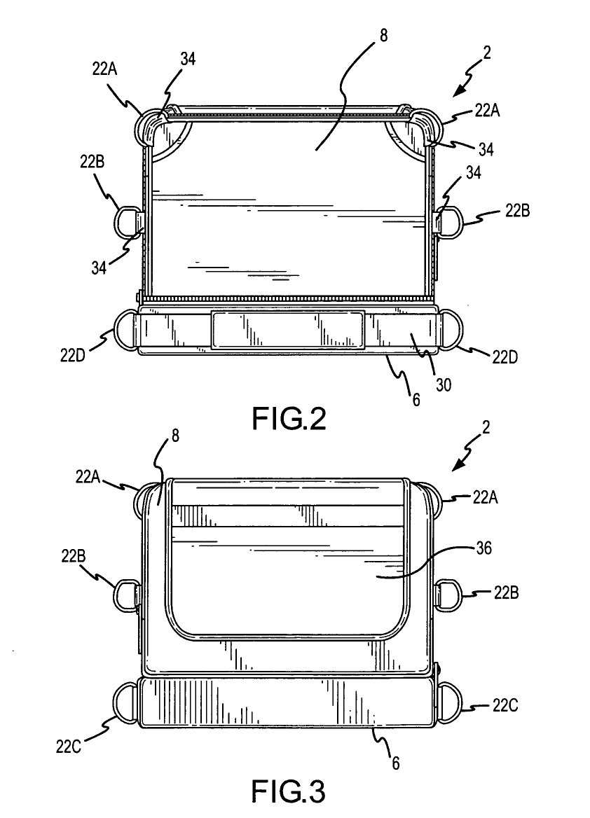

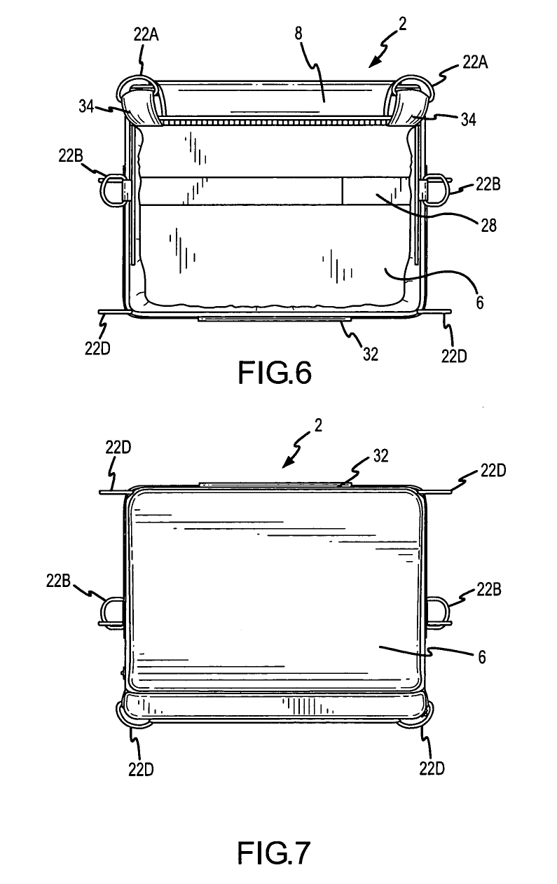

Referring now to FIGS. 1-10, an entertainment device storage case 2 adapted for interconnection to one or more vehicle seats 4 is generally shown herein. More specifically, one embodiment of the present invention includes a base portion 6, a closure portion 8, and a plurality of straps 10 selectively interconnected thereto for interconnection to at least one seat 4 of a vehicle. Another embodiment of the present invention also includes a plurality of pockets 12 integrated into the base portion 6, the closure portion 8, or both. In addition, structural support members, such as gussets 14, may be included to increase the structural capabilities of the storage case 2, and to assist in retaining the entertainment device 18 in a preferred position by restricting the amount the closure portion 8 can open. A securing strap 16 may be integrated into the base portion 6 of the storage case 2 to ensure that the entertainment device 18 remains secured during use or transportation. In operation, the base portion 6 of one embodiment of the present invention receives and secures the entertainment device 18, while the closure portion 8 provides locations for the interconnection of straps 10. The straps 10 of the present invention, which are adapted for interconnection to at least one seat 4 of a vehicle, are preferably equipped with a securing device 20, such as a clip, which selectively interconnects to retention rings 22 or loops on at least the base portion 6 or the closure portion 8 of the storage case 2.

Referring now to FIGS. 1-7, one embodiment of the present invention is shown herein that is adapted for interconnection to one or alternatively two vehicle seats 4, and which secures an entertainment device 18 such as a DVD player. More specifically, one embodiment of the present invention includes a base portion 6 that is interconnected to the closure portion 8. It will be understood by one skilled in the art that various interconnection means between the closure portion 8 and the base portion 6 may be employed without departing from the scope of the invention. The base portion 6 and the closure portion 8 also include a selective opening and closing mechanism, such as a zipper 24, which allows for the two portions to be secured together when the storage case 2 is being transported. Although a zipper 24 is shown herein, any other closure means such as snaps, hook and loop fasteners, zip lock fasteners, etc. may be used.

One embodiment of the present invention includes a perimeter edge which includes sidewall 26 that defines a volume for which the main portion of the entertainment device 18 is stored. The closure portion 8 and the base portion 6 preferably are equipped with padding to ensure that the entertainment device 18 is not damaged during transportation, and which may utilize Velcro or other means to secure the entertainment device to the base portion 6. Further, at least one securing strap 28 is interconnected to the base portion 6. More specifically, one embodiment of the present invention employs a two-piece securing strap 18 that is interconnected to the floor of the base portion 6, which is selectively interconnects over the entertainment device.

The rings 22 or loops of the storage case 2 provide locations for which straps 10 may be selectively interconnected. Alternatively, buckles, straps with hook and loop material or other possible means for interconnection may be used for the same purpose. Thus, depending on whether the device is used between two seats, or alternatively interconnected to a rear portion of a single seat will dictate which rings 22 or other means are utilized for interconnection to the straps. Further, the base portion 6 of one embodiment of the present invention may include a web 30 interconnected thereto. The web 30 provides a location for a handle 32, and a plurality of locations for the interconnection of a plurality of rings 22 or loops or other devices. In the illustrated embodiment, retention rings 22 are also interconnected to a plurality of tabs 34 integrated into the closure portion 8 and gussets 14 of the storage case 2. Although as shown herein retention rings 22 are used to provide locations for the selective interconnection of the straps 10 as discussed above, one skilled in the art will appreciate that other methods such as holes, snaps, magnets, or any other selectively interconnecting means, may be employed without departing from the scope of this invention.

The storage case 2 of the present invention is adapted for selective interconnection to at least one seat 4 of a vehicle. To achieve this, one embodiment of the present invention utilizes a plurality of straps 10 that are selectively interconnected to the storage case 2. The straps 10 in one embodiment of the present invention are equipped with securing devices 20 interconnected to at least one end thereof. In the illustrated embodiment, the securing device 20 is a swivel clip that allows for an increased number of securing options to the vehicle seats 4. The clips in this embodiment of the present invention are adapted for selective interconnection to the rings 22 that are interconnected to various locations on the storage case 2. The straps 10 of this embodiment of the present invention are made of a resilient material to accommodate various interconnection schemes and various vehicle seats 4 types and designs. However, the securing device 20 and the rings 22 of this embodiment of the present invention are manufactured of preferably the same material, such as hard plastic or metal.

It is envisioned that other storage locations will be provided on the storage case 2. More specifically, one embodiment of the present invention employs a closure portion 8 with an additional compartment 36 integrated therein, which may be used to store items such as DVDs, CDs, VCR tapes, etc. One skilled in the art will appreciate that any number of pockets or compartments may be included on the present invention without departing from the scope thereof.

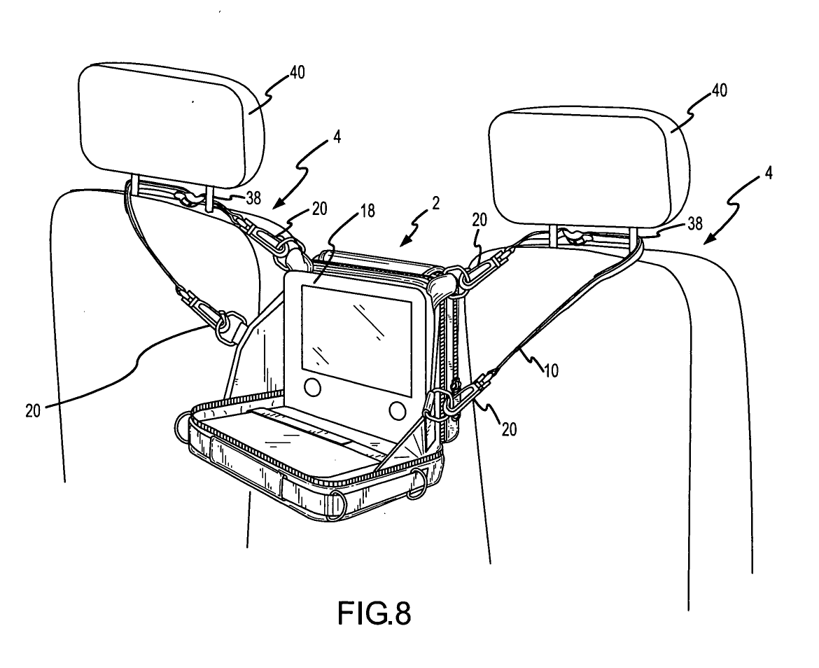

Referring now to FIG. 8, one method of securing the storage device 2 is shown and described herein. More specifically, one embodiment of the present invention is adapted for interconnection with two adjacent bucket seats 4 of an automobile. To deploy the storage device 2, the user opens the previously described storage compartments 36 to obtain the straps 10. Next the storage device 2 is opened to expose the entertainment device 18 therein. The securing device 20 of a strap 10 is then selectively interconnected to both upper rings 22A of the closure portion 8, then looped around the studs 38 of a headrest 40, wherein the other end of the strap 10 is selectively interconnected to the gusset rings 22B. To aid in the support of the system, additional straps 10 may be used to connect the lower base rings 22C to the upper base rings 22D, wherein the strap 10 will be positioned around a bottom portion of the seat 4. It is envisioned that all the straps will have mechanisms included thereon which allow for selectively increasing or decreasing the length thereof, such that the strap system may be tightened to provide a snug fit around the seats 4, thus ensuring a proper suspension between the two seats 4 to prevent injuries from sudden stops or turns of the vehicle. It is also envisioned that the devices used to increase or decrease the length of the straps 10, such as buckles, will be situated away from the headrest 40 when in use, thus ensuring that there are no hard spots on the headrest 40 that may be uncomfortable to a passenger.

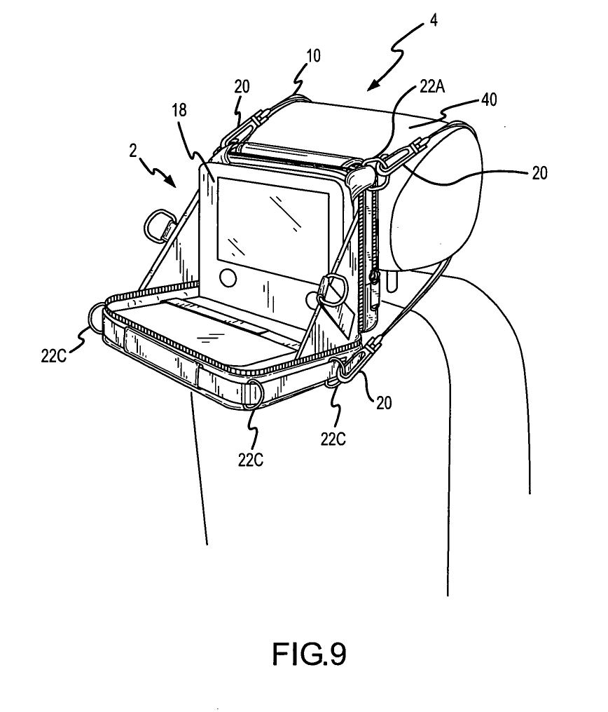

Referring now to FIG. 9, another method of securing the storage device 2 of the present invention is shown herein. More specifically, this embodiment of the present invention is adapted for selective interconnection to a single seat 4 of a vehicle. Similar to the method described above, the storage device 2 will be open to expose the entertainment device 18 contained therein. The straps 10 are selectively interconnected to the top rings 22A of the closure portion 8, wherein they are crossed over the front of the headrest 40 and selectively interconnected to one or more of the lower base rings 22C and tightened. Again, hard points on the straps 10, generally attributed to devices used for tightening, are situated such that passengers head or neck will not come in contact therewith. Further, the straps may also be utilized around a lower part of the seat (not shown) or other location which provides for securement. This method of interconnection is more suited for a single rear compartment passenger, wherein the previously described method of interconnection is more suited for the situations where there are a plurality of passengers in the rear seat of the vehicle.

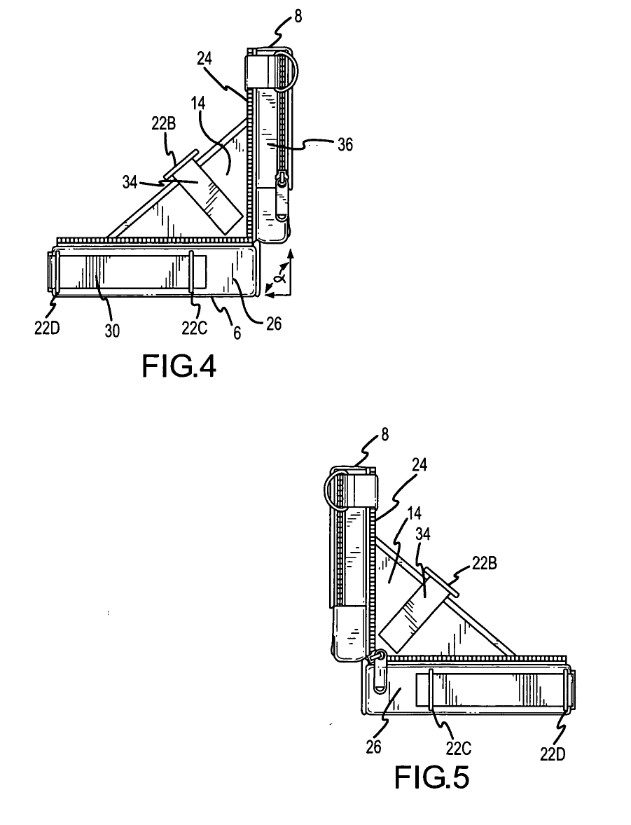

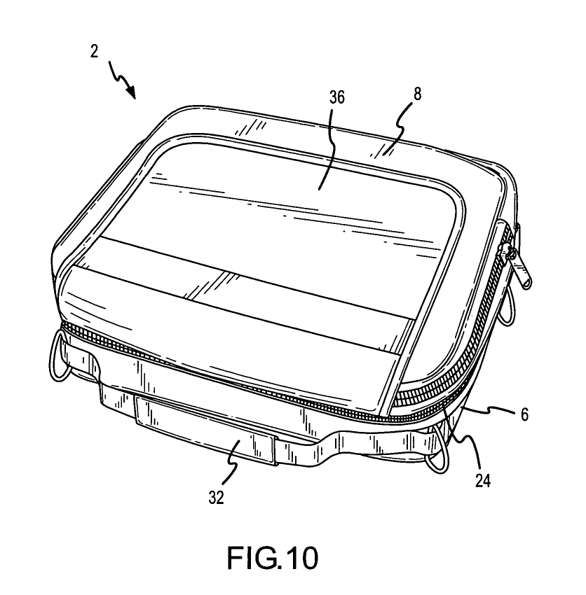

Referring now to FIG. 10, a perspective view of one embodiment of the present invention is shown in a second, closed position. As previously described above, one embodiment of the present invention includes a closure portion 8 and a base portion 6 that may be selectively interconnected with a zipper 24 or other closure means. As appreciated, by one skilled in the art, any selective interconnection means such as hook and loop materials, buckles, snaps, etc. may be employed without departing from the scope of this invention. As also illustrated herein, a plurality of pockets or compartments 36 may be included on the present invention, on either the closure portion 8 or the base portion 6, to provide locations for storage of electronic media, for example. Also, as briefly described above, the portions of the storage case contain sufficient cushioning, such that the entertainment device stored therein is protected. Further, as distinctly shown in FIG. 1, one embodiment of the present invention includes gussets 14 that provide locations for rings 22, and that provides support between the closure portion 8 and the base portion 6 when in use. In the configuration shown in FIG. 10, the gussets 14 are folded and stored inside the storage device 2, thus providing additional padding and protection to the entertainment device stored therein. Furthermore, the gussets 14 prevent the closure portion 8 from being overextended from the base portion 6, and further provide a sun-screen to the viewing surface of the DVD player. As shown in FIG. 4, the closure portion 8 is shown opened to an opening angle ∝ of approximately 90 degrees, although this angle may be modified by changing the size of the gusset 14. Although the illustrated embodiment is shown with exposed zippers 24, it is well within the scope of this invention to include flaps over the zippers to further protect the contents therein from fluids for example.

Referring again to FIGS. 1-10, a manner of making one embodiment of the present invention is shown and described herein. Preferably, one embodiment of the present invention is constructed of compliant material, thus making it soft and less likely to cause injury if a strap 10 should fail, for example. However, one skilled in the art will appreciate that the entire storage device 2, or portions thereof, may be constructed of rigid materials such as molded plastic, etc. to increase structural strength, for example. The compliant materials used in one embodiment of the present invention include leather, nylon, polyester, cloth, plastic, or combinations therein.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

1. A portable storage case adapted for interconnection to at least one seat for securing an entertainment device, comprising:
a base portion defined generally by a first perimeter edge, wherein said base portion is adapted to support the entertainment device;
a closure portion defined by a second perimeter edge, said closure portion hingedly interconnected to said base portion, wherein said closure portion may be selectively opened and closed;
at least one retention loop interconnected to said base portion and said closure portion proximate to said perimeter edges; and
an adjustable strap adapted for selective interconnection to said at least one retention loop, wherein said storage case may be operably interconnected to a single seat, or alternatively between two seats, wherein the electronic device can be viewed when the closure portion is opened from said base portion.

2. The storage case of claim 1, further comprising a securing means interconnected to said at least one of said base portion and said closure portion which is adapted to operably retain the entertainment device within said securing means.

3. The storage case of claim 2, wherein said securing means comprises an adjustable strap.

4. The storage case of claim 2, wherein said adjustable strap is interconnected to said retention loop with a securement buckle.

5. The storage case of claim 1, wherein said means for selective interconnection comprises at least one of a zipper, a buckle and a hook and loop material.

6. The storage case of claim 1, wherein said base portion and said closure portion are comprised of a flexible material.

7. The storage case of claim 1, further comprising a flexible gusset interconnecting to said base portion to said closure portion along said first perimeter edge and said second perimeter edge, wherein said closure portion is restricted from opening beyond a predetermined position.

8. The storage case of claim 7, wherein said closure portion and said base portion open to form an angle of no more than about 120 degrees.

9. The storage case of claim 1, wherein said base portion is adapted to rest on a console between two seats of a vehicle.

10. A storage device adapted for selectively retaining an electronic entertainment device between two seats or alternatively behind a single seat in a vehicle, comprising:
a base portion defined by a front edge, a rear edge, and two lateral edges extending therebetween, said base portion operatively sized to support said entertainment device;
a closure portion defined by a front edge, a rear edge, and two lateral edges extending therebetween, said closure portion hingedly interconnected along at least said rear edge to said base portion, wherein said closure portion can be selectively opened and closed;
a securement means operably interconnected to an interior surface of at least one of said base portion and said closure portion which is adapted to retain said electronic entertainment device within said storage device;
at least one interconnection means interconnected to each of said lateral edges of said base portion and said closure portion, and which is adapted for interconnection to a strap which is sized to secure said storage device to the vehicle seat; and
a closure means interconnected to at least a portion of said base portion and said closure portion, wherein said storage device can be selectively secured in a closed position;

11. The storage device of claim 10, wherein said securement means comprises an adjustable strap.

12. The storage device of claim 10, wherein said interconnection means comprises at least one of a loop, a ring, a buckle and a strap.

13. The storage device of claim 10, wherein said closure means comprises at least one of a zipper, a hook and loop material, a buckle, a snap and a strap.

14. The storage device of claim 10, further comprising at least one gusset interconnected on a lateral edge of said base portion and said closure portion, wherein said closure portion is restricted from opening beyond a predetermined position.

15. The storage case of claim 10, further comprising a handle interconnected to at least one of said base portion on said closure portion.

16. A storage case for an electronic device which is adapted for interconnection between two seats of a vehicle or alternatively behind a single vehicle seat, comprising:
a base portion hingedly interconnected to a closure portion, each of said base portion and closure portion comprising a front edge, a rear edge and lateral edges positioned therebetween;
an adjustable strap interconnected to an interior surface of at least one of said base portion and said closure portion which is adapted to secure said electronics device within said storage case;
at least one retention ring interconnected to said lateral edges of said base portion and said closure portion; and
a first adjustable strap adapted for interconnection to a vehicle seat on a first end and said at least one retention ring on a second end; and
a second adjustable strap adapted for interconnection to a vehicle seat on a first end and said at least one retention ring on a second end, wherein said storage case an be suspended between said first seat and said second seat or alternatively behind a single vehicle seat.

17. The storage case of claim 16, wherein said adjustable strap further comprises a hook and loop material.

18. The storage case of claim 16, wherein said at least one retention ring comprises a flexible, non-metallic material.

19. The storage case of claim 16, further comprising a gusset interconnected along said lateral edges of said base portion and said closure portion, wherein said closure portion is restricted from opening beyond a predetermined position.

20. The storage case of claim 16, further comprising a carrying handle interconnected to at least one of said base portion and said closure portion.
